(19) United States
(12) Patent Application Publication
(10) Pub. No.: US 2011/0085175 A1
(43) Pub. Date: Apr. 14, 2011

(54) SURFACE MEASUREMENT, SELECTION, AND MACHINING

(75) Inventors: George PETRESCU, Houston, TX (US); James Edd WHEELER, Houston, TX (US)

(73) Assignee: Furmanite Worldwide, Inc., Richardson, TX (US)

(21) Appl. No.: 12/576,615

(22) Filed: Oct. 9, 2009

(51) Int. Cl. G01B 11/24; G06F 15/00

(52) U.S. Cl. 356/601; 702/167

(57) ABSTRACT

Systems, processes, articles of manufacture, and techniques may be used to measure a surface to be machined. In particular implementations, a representation of a surface to be machined may be determined. Measuring the surface may include measuring a plurality of surface points at each of a plurality of surface measurement locations with a measurement system moving over a surface and measuring the position of the measurement system. Determining a representation of the surface to be machined may include determining an estimated shape for the surface based on the surface measurements at the surface measurement locations. The surface measurements, the surface measurement locations, and the estimated shape may be stored in computer memory for future retrieval and use.

### BACKGROUND

Machine surfaces are typically deformed during service. For example, the surfaces may become pitted, dented, cracked, and/or warped. These deformations may adversely affect other machine components (e.g., bearings, seals, gaskets, etc.) that interface with the surfaces. For example, the deformations may cause the other components to wear prematurely and/or allow the machine to lose fluids, negatively affecting the functionality of the machine. In order to restore the functionality of the machine, these surfaces need to be machined to restore optimal function.

The process of machining surfaces is quite difficult for large machines, however. For example, machines used in the mining industry and off-shore mooring systems may have bearing races that span 150 feet in diameter or more. Other similar surfaces to be machined could have various shapes, such as in the case of turbine cases. For machines like these, even determining the current condition of the surface to be machined, much less doing it accurately, is problematic, as there can be a multitude of variations, some of them quite small, over the surface. Thus, it is difficult to know what problems the surface has, much less how best to correct them. Additionally, controlling the machining of the surface to an accurate degree is difficult across a great expanse.

### SUMMARY

This disclosure relates to the measurement, selection, and machining of surfaces. In one general aspect, a system for determining a representation of a surface to be machined may include a measurement system, a laser tracking system, and a computer system. The measurement system may be movable over a surface to be machined and be adapted to measure a plurality of surface points at each of a plurality of surface measurement locations. The laser tracking system may be adapted to measure the position (e.g., position and/or orientation) of the measurement system. The computer system may be adapted to receive the surface measurements from the measurement system and the measurement system positions from the laser tracking system, a plurality of the measurement system locations corresponding to the surface measurement locations, and to determine an estimated shape for the surface to be machined based on the surface measurements at the surface measurement locations. The computer system may also store the surface measurements, the surface measurement locations, and the estimated shape.

In particular implementations, the measurement system may be coupled to a cart that is movable in an automated manner over the surface to be machined. The cart may include a travel mechanism (e.g., rollers and drive motors) adapted to contact and move over the surface to be machined.

The system may also include a central station and an arm rotatably coupled to the central station and extending to the cart. The arm may be adapted to cause the cart to move around the central station.

In certain implementations, the measurement system may measure a number of points at each measurement system location. The measurement system may, for example, include a laser scanner adapted to measure the surface at a number of points.

The computer system may be coupled to the measurement system and the laser tracking system. The computer system may, for example, use a least squares analysis to determine the estimated shape.

The laser tracking system may include a laser source located away from the surface to be machined and a laser target coupled to the measurement system. The laser target may, for example, be a laser target that is capable of detecting its orientation with respect to a reference system.

In another general aspect, a computer-implemented process for determining a representation of a surface to be machined may include measuring a plurality of surface points at each of a plurality of surface measurement locations with a measurement system movable over the surface and measuring the position of the measurement system. The process may also include determining an estimated shape for the surface to be machined based on the surface measurements at the surface measurement locations. The surface measurements, the surface measurement locations, and the estimated shape may be stored in computer memory for later recall.

In certain implementations, measuring the plurality of surface points includes measuring the surface points with a measurement cart includes the measurement system and moves in an automated manner over the surface to be machined.

Particular implementations may include determining whether additional surface measurements are needed and adjusting the position of the measurement system based on the results of the determination. Adjusting the position of the measurement system may, for example, include generating a movement command for a measurement cart, including for one or more of its components, to which the measurement system is coupled.

Measuring the position of the measurement system may include sending a laser beam from a laser source located away from the surface to be machined to a laser target coupled to the measurement system. Measuring the position of the measurement system may also include determining the orientation of the measurement system with the laser target.

In another general aspect, a system for determining a representation of a surface to be machined may include means for measuring a plurality of surface points at each of a plurality of surface measurement locations, the measuring means movable over a surface to be machined, and means for measuring the position of the measuring means. The system may also include means for determining an estimated shape for the surface to be machined based on the surface measurements at the surface measurement locations. The system may also include means for storing the surface measurements, the surface measurement locations, and the estimated shape.

The means for determining the estimated shape may be further operable to determine whether additional surface measurements are needed and adjust the position of the measuring means based on the results of the determination. Adjusting the position of the measuring means may include generating a movement command for a measurement cart to which the move measuring means is coupled. The means for measuring the position of the measuring means may include a laser source means located away from the surface to be machined and a laser target means coupled to the measuring means.

In a particular aspect, a system for determining a representation of a surface to be machined may include a measurement cart, a central station, a laser tracking system, and a computer system. The measurement cart may be movable in an automated manner over a surface to be machined and include rollers adapted to allow the cart to contact and move over the surface to be machined, a motor to drive the rollers, and a laser scanner adapted to measure a plurality of surface points at each of a plurality of surface measurement locations. The central station may have an arm rotatably coupled thereto, and the arm may extend to the cart and be adapted to cause the cart to move in a circle around the central station. The laser tracking system may be located near the central station and adapted to measure the location and orientation of the laser scanner. The laser tracking system may include a laser source located away from the surface to be machined, a sensor co-located with the laser source and adapted to measure the location of the laser scanner, and a laser target coupled to the laser scanner and adapted to measure the orientation of the laser scanner. The computer system may be coupled to the cart and the laser tracking system. The computer may be adapted to receive the surface measurements from the laser scanner and the laser scanner orientations and the laser scanner locations from the laser tracking system, a plurality of the laser scanner locations corresponding to the surface measurement locations, to determine an estimated shape for the surface to be machined based on the surface measurements at the surface measurement locations, and to store the surface measurements, the surface measurement locations, and the estimated shape.

Various implementations may have one or more features. For example, systems, processes, articles of manufactures, and techniques for measuring a surface to be machined may generate a multitude of measurements, both along and transverse to a path, for the surface to be machined. Thus, an accurate rendition of the entire surface may be generated. The better rendition of the surface can also lead to a more accurate estimated shape being generated for the surface. Moreover, the measurements may be made in an automated manner, which reduces the errors that humans may introduce in setting up, taking, and recording measurements at a number of positions on a surface. Additionally, the measurements may be made with respect to non-circular surfaces. For example, the measurements may be made with respect to a Cartesian system or cylindrical surfaces.

The features of one or more implementations are set forth in the accompanying drawings and the description below. Other features will be apparent from the description and drawings, and from the claims.

### DESCRIPTION OF DRAWINGS

FIG. 1 is a line drawing illustrating an example system for measuring a surface to be machined.

FIG. 2 is a graph illustrating the measurements for an example surface to be machined.

FIG. 3 is a line drawing illustrating an example measurement cart.

FIG. 4 is a block diagram illustrating an example computer system.

FIG. 5 is a flow diagram illustrating an example process for measuring a surface to be machined.

FIG. 6 is a flow diagram illustrating an example process for selecting a surface to be achieved by machining.

FIG. 7 is a line drawing illustrating an example system for machining a surface.

FIGS. 8A-B are line drawings illustrating an example machining cart.

FIG. 9 is a flow diagram illustrating an example process for machining a surface.

Like reference symbols in the various drawings indicate like elements.

### DETAILED DESCRIPTION

Systems, processes, articles of manufacture, and techniques for measuring, selecting, and machining surfaces are described. In particular implementations, the systems, processes, articles of manufacture, and techniques use laser targeting and computer control and analysis to measure a surface to be machined (e.g., a bearing race), determine an appropriate surface to be achieved by machining, and machine the appropriate surface. The laser targeting and computer control and analysis may achieve tight tolerances even for surfaces that have great expanses (e.g., 150 feet in diameter). As described in more detail below, the systems, processes, articles of manufacture, and techniques have many details and features. Other implementations are also possible.

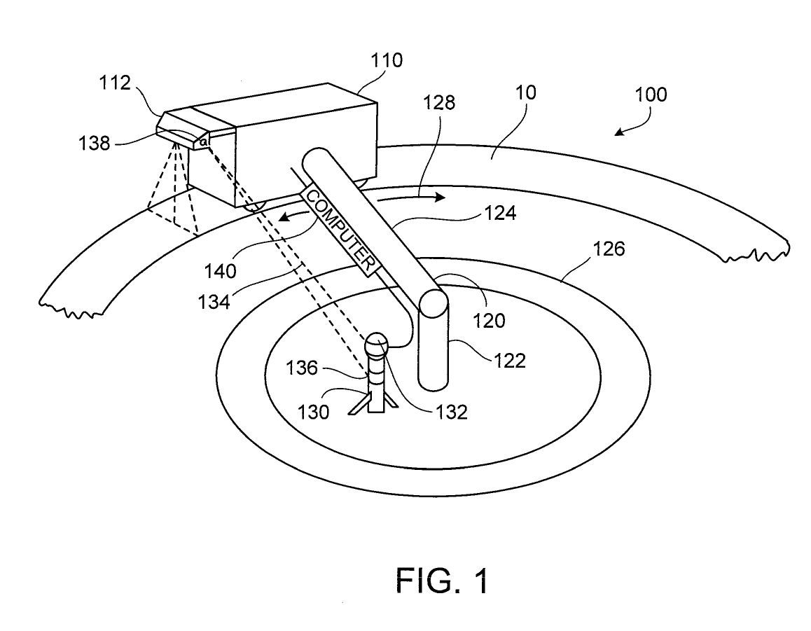

FIG. 1 illustrates an example system 100 for measuring a surface to be machined. As illustrated in FIG. 1, the system 100 is measuring the surface of a bearing race 10. A bearing race is typically an annular surface, and in industrial applications can have a diameter of up to 150 feet or even larger. The system 100 includes a measurement cart 110, a guide system 120, a measurement system 130, and a computer system 140.

The measurement cart 110 is adapted to travel over and measure the surface to be machined, which is a surface of the bearing race 10 in the current example. In particular implementations, the cart 110 may include rollers (e.g., wheels) that allow it to move over the surface. The cart 110 includes a surface measurement system 112 that measures the surface of the bearing race 10. The surface measurement system 112 may measure the surface by a variety of techniques. For example, the surface measurement system 112 may include a laser scanner (e.g., laser and sensor) that scam; the surface to measure several surface points (in linear or planar fashion) at each location of the cart 110. As another example, the surface measurement system 112 may include one or more electrical, mechanical, or electro-mechanical sensors that travel over the surface with the cart 110 to measure the surface. The surface measurement system 112 may take measurements at a multitude of locations as the cart 110 travels over the surface of the bearing race 10. Thus, a profile of the surface around the entire bearing race 10 may be developed.

In particular implementations, the surface measurement system 112 may measure a number of surface points at each cart location. In the illustrated implementation, for instance, the surface measurement system 112 may measure a number of points in the radial direction of the bearing race 10 at each cart location. Thus, as the cart 110 travels around the bearing race 10, it may make measurements to develop a profile of the entire surface.

The guide system 120 is adapted to guide the measurement cart 110 over the surface of the bearing race 10. In the illustrated implementation, the guide system 120 includes a central alignment station 122 and a rotatable arm 124 extending therefrom. The central alignment station 122 may be positioned at the center of the bearing race 10, and the arm 124 may couple to the cart 110 to encourage it to move in a circular path (in the direction of arrow 128) around the central alignment station 122, and over the surface. The guide system 120 may also include a support structure 126 for the arm 124. The support structure 126 may assist in keeping arm 124 aligned. In particular implementations, the support structure 126 may act as a bearing for the boom.

The measurement system 130 is adapted to take measurements that indicate the position (e.g., location and/or orientation) of the surface measurement system 112 as the measurement cart 110 travels over the surface of the bearing race 10. The measurement system 130 may accomplish this by measuring the position of the measurement cart 110, from which the position of the surface measurement system 112 may be determined, or measuring the position of the surface measurement system 112 directly.

In the illustrated implementations, the measurement system 130 includes a centrally located laser source 132. An appropriate laser source may, for example, be the T3 laser tracker from Automated Precision Inc. (API) of Rockville, Md. The laser tracking system typically does not have to be located with a high degree of precision relative to the surface to be machined, as long as it is located in a position at which it is relatively stable relative to the surface.

The laser source 132 may illuminate one or more laser targets 138 (e.g., passive, active, or smart targets) on the measurement cart 110 by a laser beam 134. The laser target(s) 138 may be located at any appropriate location on the cart 110. One or more sensors 136 for the laser beam 134 may be located with the laser source 132 to also receive the laser beam 134. In particular implementations, the sensor(s) 136 may be located basically at the same point as the laser source 132. Thus, the laser beam 134 may basically traverse the same path from the laser source 132 and to the sensor(s) 136. In certain implementations, the laser beam 134 may be routed (e.g., by an optical element) from the receiving point to the sensor(s) 136, which could be located at other points in the measurement system 130. The sensor(s) 136 may produce three-dimensional information regarding the location of the surface measurement system 112. Using two angle encoders and the time of flight to the laser target, for example, may produce the three-dimensional coordinates. The three-dimensional information can be in Cartesian coordinates (i.e., x, y, z), cylindrical coordinates (i.e., r, θ, z) , or any other appropriate coordinates. The laser target(s) 138 and/or sensor(s) 136 may also measure the orientation of the measurement system 112.

The computer system 140 is adapted to receive and collate the information regarding the surface measurements and the measurements of the surface measurement system to produce a profile of the surface. The computer system 140 may, for example, include memory for storing the measurements and a processor for collating the measurements. Additionally, the computer system 140 may determine an estimated shape for the surface. In the illustrated implementation, the surface of the bearing race is planar; thus, the estimated surface may be planar. In other implementations, the surface to be machined may have other appropriate shapes (e.g., cylindrical, spherical, parabolic, etc.) and, in general, may have any two or three dimensional shape. The estimated surface may be modeled to the surface shape. In certain implementations, the computer system 140 may have a pre-stored reference shape relative to which the surface profile is measured. The estimated shape represents the actual surface.

In one mode of operation, the computer system 140 may receive the measurements generated by the surface measurement system 112 and the measurements generated by the laser tracking system 130 by appropriate techniques (e.g., wireline or wireless). Upon receiving the measurements, the computer may collate them so that the measurements taken by the surface measurement system 112 at one location of the surface measurement system 112 are associated with the measurements of the surface measurement system taken by the laser tracking system 130. This may, for example, be accomplished by comparing time stamps associated with the measurements or by examining their arrival times. The association allows the surface profile to be developed relative to the laser tracking system 130.

Upon developing the surface profile, the computer system 140 may also determine an estimated shape for the surface. The estimated shape may represent a best approximation of the surface. The estimated shape may, for example, be computed with various techniques. In particular implementations, for example, the estimated shape may be determined by performing a statistical analysis (e.g., least squares analysis). Other implementations may use peaks and valleys analysis or other techniques. The estimated shape may be output to a user (e.g., through a display or print out) and/or stored in memory for later access.

In certain implementations, an operator may adjust the estimated shape to determine the machining shape. For example, the computer system 140 may allow the operator to adjust the location of the estimated shape (e.g., up or down), the size of the estimated shape (e.g., larger of smaller), or the orientation of the estimated shape (e.g., horizontally, vertically, or inclined). The operator may specify whether 10 use the adjusted shape as the machining shape. As discussed below, in certain implementations, the computer system may also provide feedback regarding the machining operations (e.g., number of passes) to achieve the operator-specified shape.

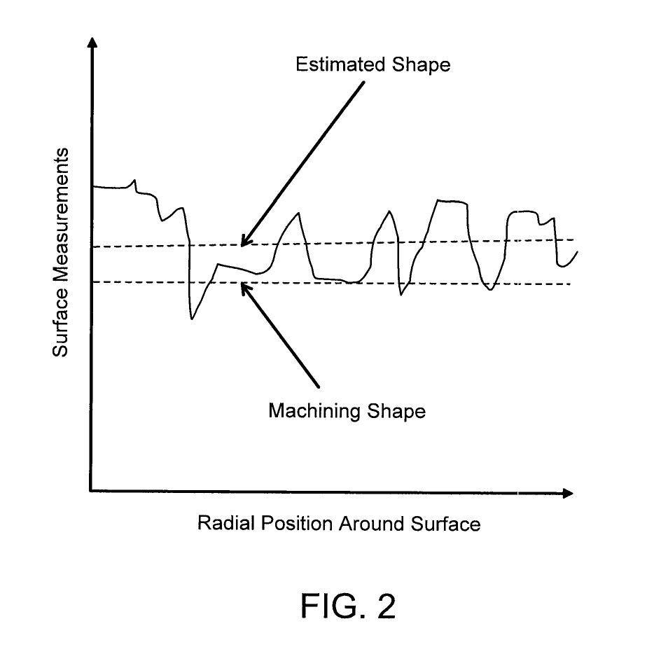

FIG. 2 illustrates the measurements of an example surface to be machined. In this implementation, the surface is planar and has a number of peaks, valleys, plateaus, chips, and dents. The measurement granularity used by the surface measurement system 112, however, has been able to identify these characteristics. The measurement granularity of the surface measurement system 112 may be adjusted based on the type of surface being measured.

FIG. 2 also illustrates an estimated shape (e.g., a plane) that has been determined for the surface. As discussed previously, the estimated shape is based on the measurements of the surface. Thus, the estimated shape approximates the true surface to be machined.

FIG. 2 additionally illustrates a machining shape for the surface. The machining shape, which will be discussed in more detail below, represents the shape to which the machining will be performed. Thus, the machined surface may look similar to the surface cut by the machining shape. In certain implementations, the estimated shape may be the same as the machining shape. In other implementations, an operator and/or automated process may specify alterations to the estimated shape to achieve the machining shape.

It should be noted that FIG. 2 is a simplified version of a surface. In particular, it only represents the surface along one radius. Adding radial measurements will typically result in a more accurate, but complicated, representation surface.

System 100 has a variety of features. For example, as opposed to measuring the surface through measurement of several discrete points around a radius of the bearing race 10, system 100 generates a multitude of measurements (e.g., hundreds or more) over the surface to be machined in an automated manner. Thus, system 100 generates a more accurate rendition of surface, especially versus taking a limited number of measurements (e.g., three (spaced at 120 degrees) or four (spaced at 90 degrees)) at an arbitrary set of points and interpolating in between, which may miss important data and result in an estimated shape that does not resemble the true shape. Moreover, the setup for the measurements does not require high precision, as the relative positions may be accurately determined with the laser tracking system. Thus, manpower and errors are reduced. Additionally, system 100 can measure the surface in the radial dimension (in the case of planar circular surfaces), depth (in the case of cylindrical surfaces), or full width (in the case of other surfaces). Thus, system 100 can generate a three-dimensional representation of the surface. The automated nature of the measurements once the system is set up also eliminates operator error in having to set-up, take, and record measurements at a number of points around the bearing race. A better rendition of the :surface can lead to a more accurate estimated shape being generated for the surface. Moreover, it can lead to more accurate determination of a machining shape, which can result in less machining and down time during the actual machining operations, as explained in more detail below. System 100 can be used for measuring planar surfaces (e.g., horizontal, vertical or at any angle in between), cylindrical surfaces, or any other surface needed of various shapes. As a further example, because the laser tracking system can //correinuously measure the distance from the laser source to the surface measurement system, and the distance is pre-determined (e.g., by the fixed length of the boom or otherwise), if this distance is found to vary, it may indicate that the laser beam has encountered an atmospheric variation (e.g., a density variation) and, therefore, that its position measurements may be affected. Corrective measures can then be applied to ensure that the laser measures as expected.

Although FIG. 1 illustrates an example implementation of a surface measurement system, other implementations of a surface measurement system may include fewer, additional, and/or a different arrangement of components. For example, all or part (e.g., the support structure 126) of the guide system 120 is not required in all implementations. In particular implementations, for instance, the measurement cart 110 could be self-power and self-guiding. And in certain implementations, the cart 100 is not required. For instance, the surface measurement system 112 may be maneuvered by an operator (e.g., by hand) over the surface to be machined. Thus, the measurement system, along with its supporting components, does not have to touch the surface to be machined. In general, the measurement system may be positioned at any distance at which it produces the required accuracy for the surface measurements. Moreover, a measurement system could be positioned above, under, next to, inside of, or at any other appropriate position relative to a surface to be machined and move over the surface at any appropriate relationship (e.g., above, under, next to, or inside of).

As an additional example, other types of guide systems (e.g., X-Y) may be used. X-Y systems typically have two positioning arms that move in angular directions. Thus, the surface may be measured in any coordinate system (e.g., Cartesian or cylindrical). Moreover, the surface to be machined does not have to be circular. As another example, the laser source 132 does not have to located at the exact center of the bearing race 10. In certain implementations, for instance, it could be located a few meters off of the center. Additionally, as space permits, its may be located away from the central station, or even outside the surface to be machined. Thus, the system can accommodate situations in which obstacles exist in between the station and the cart. As a further example, the laser source 132 could be located on the cart (e.g., coupled to the measurement system), and the laser target away from the cart. Moreover, a number of laser sources and laser targets could be used, as discussed in more detail below. As an additional example, although illustrated as being coupled to arm 124, the computer system 140 could be located at any of a number of positions in the system (e.g., on the measurement cart 112, at the central location, or in the laser tracking system 140) or off the system.

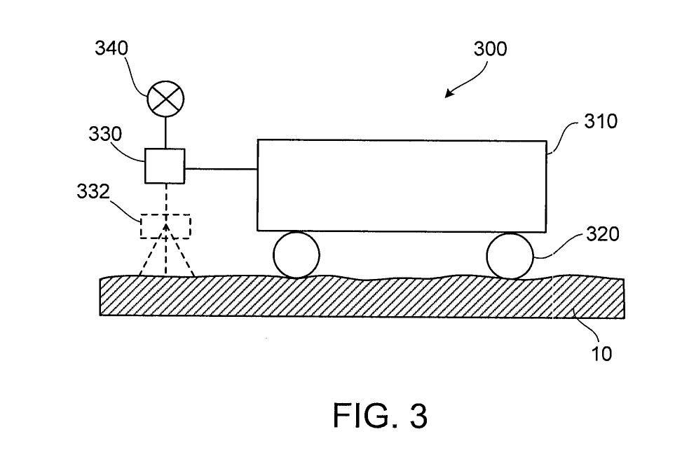

FIG. 3 illustrates an example measurement cart 300. The measurement cart 300 may, for example, be used in system 100. Measurement cart 300 includes a body 310, a travel mechanism 320, a surface measurement system 330, and a laser target 340.

The body 310 provides a frame for the measurement cart 300 and allows the measurement cart 300 to be moved. In particular implementations, the body 310 may be coupled to an arm so that the arm exerts a force on the body 310 to guide it and/or cause it to move. The movement may also cause the travel mechanism 320 to move. As illustrated, the travel mechanism 320 includes rollers for moving the cart 300 relative to the bearing race 10. In other implementations, the travel mechanism 320 may include one or more motors inside the body 310 for driving the travel mechanism.

The surface measurement system 330 is coupled to the body 310 and includes the device(s) for measuring the surface. In this particular implementation, the surface measurement system is a laser scanner that scans a laser beam 332 to measure a number of surface points that are lateral to the cart's direction of travel. The laser scanner may, for example, be an I-Scan, Intelliscan 360, or White Light Laser from Automated Precision Inc. (API) of Rockville, Md. Thus, the surface measurement system 300 may measure a number of surface points at each location of the cart 300.

Coupled to the surface measurement system 300 is a laser target 340. The laser target 340 may be illuminated by a laser tracking system and redirect (e.g., reflect) the laser beam to a sensor located away from the measurement cart 300. The reflection may allow the sensor to compute the three-dimensional position of the surface measurement system 330, which may be combined with the surface measurements of the surface measurement system 330 to generate the surface profile.

The laser target 340 may generally be any device for receiving a laser beam. In certain implementations, the laser target may be an active target, which is one that may orient itself to maintain alignment with the laser source. In particular implementations, the laser target 340 may be a smart target, which is a target that can determine its orientation (e.g., roll, pitch, and yaw) with respect to a reference system. An appropriate smart target is the Smart Target from Automated Precision Inc. (API) of Rockville, Md. The orientation may be combined with the three-dimensional position of the surface measurement system and the surface measurements to generate the surface profile. A smart target may also orient itself to maintain alignment with the laser source.

Although cart 300 is illustrated as having rollers 320 for moving the cart over the surface to be machined, in other implementations, the cart may use other techniques means for support and propulsion (e.g., tracks, a boom arm, etc.).

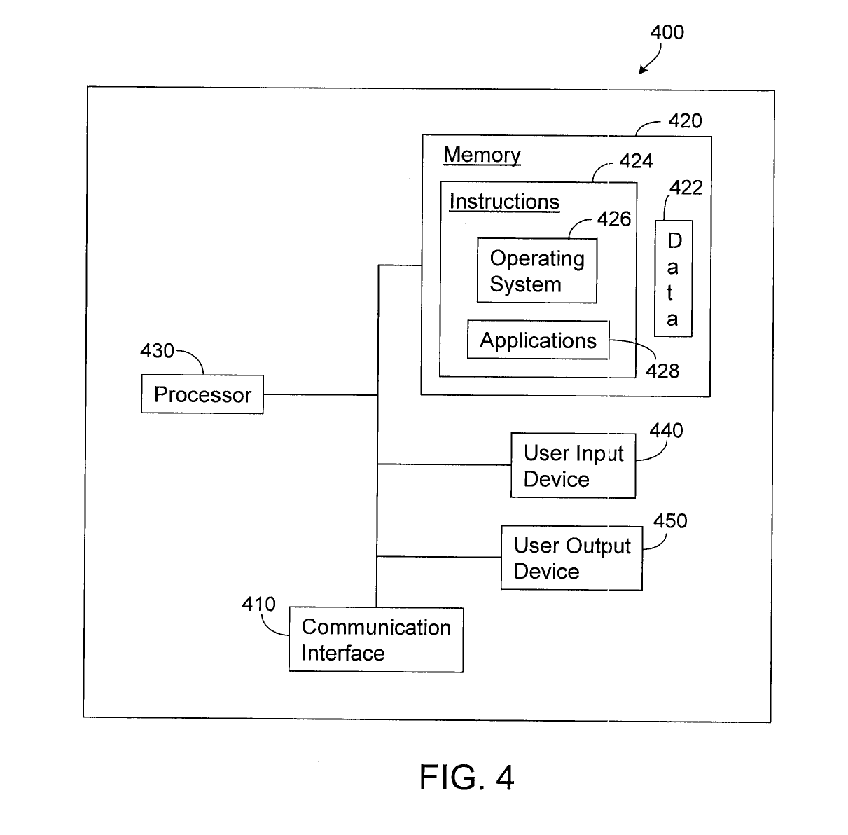

FIG. 4 illustrates an example computer 400 system that may be used for system 100. Computer system 400 includes a communication interface 410, memory 420, and a processor 430.

Communication interface 410 may send information (e.g., data and commands) to and receive information from the measurement cart 120 and the measurement system 120. Communication interface may, for example, be a network interface card, a modem, a wireless transceiver, or any other device for receiving and/or sending information. Communication interface 410 may operate by wireline (e.g., IEEE 802.3) or wireless (e.g., IEEE 802.11 or IRDA) techniques.

The data received by the communication interface 410 may be stored in a data portion 422 of memory 420. Memory 420 may, for example, include random-access memory, read-only memory, compact-disk read-only memory, and/or any device(s) for storing information. Memory 420 also includes an instruction portion 424 which includes an operating system 426 (e.g., Unix, Linux, Windows, etc.) and applications 428. The instructions 424 may be used by the processor 430 in performing the operations of the computer system 400.

The processor 430 is coupled to memory 420 and the communication interface 410 and is operable to perform the operations to the computer 400 system. The processor 430 may, for example, be a digital processor (e.g., a microprocessor) or any other device for manipulating data in a logical manner.

The computer system 400 also includes a user input device 440 and a user output device 450. The user input device 440 may allow an operator to provide information (e.g., data and commands) to the computer system 400. The user input device 420 may, for example, be a keyboard, keypad, stylus, touch screen, or any other device that allows a user to indicate information to a computer. The user output device 450 may allow computer 400 to provide output to a user. The user output device may, for example, be a display, a printer, or any other device that allows a user to receive information from a computer.

In one mode of operation, the computer system 400 may record and collate the measurements made by the measurement cart 110 and the laser tracking system 130. For instance, the communication interface 410 may independently receive the measurements from the measurement cart 110 and the laser tracking system 130. The computer system 400 may store these measurements in the data portion 422 of memory 420. The processor 430 may then collate the measurements so that the measurements of the surface measurement system 112 at one location are associated with the surface measurement system location. A representation of the surface may be output to an operator through the user output device 450.

After storing and collating the measurements, the processor 430 may then determine an estimated shape plane based on the collated measurements. The estimated shape may be output to an operator through the user output device 450, and the estimated shape may be stored in the data section 422 of memory 420.

In particular implementations, the computer system 400 may control the measurements and/or movements of the measurement cart 110. For example, the computer system 400 may command the cart to move to particular locations of the surface to be machined and to take measurements when the measurement cart 110 is at the appropriate location. The computer system 400 may, for instance, determine when the measurement cart 110 is at the appropriate location by receiving measurements from the laser targeting system 130.

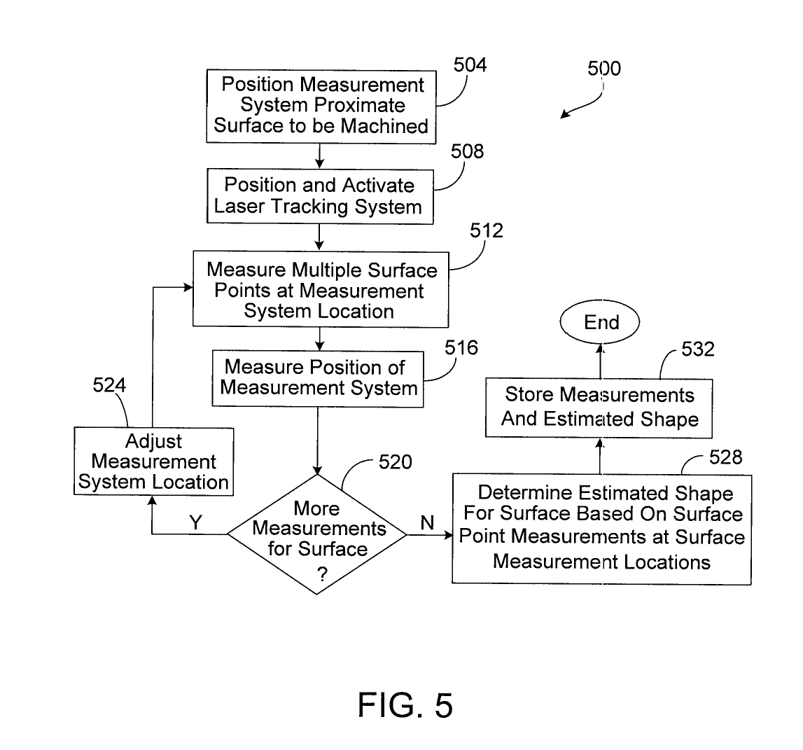

FIG. 5 illustrates an example process 500 for measuring a surface to be machined. Process 500 may, for example, illustrate the operation of a system such as system 100.

Process 500 calls for positioning a measurement system proximate the surface to be machined (operation 504). For example, a measurement cart such as the cart 110 may be placed on the surface to be machined. In other implementations, however, a measurement cart and/or measurement system does not have to touch the surface to be machined (e.g., the measurement cart and/or system could be suspended by a boom). In general, a measurement cart and/or system may be positioned at any distance at which the measurement system may produce the required accuracy for the surface measurements. Moreover, a measurement system and/or cart could be positioned above, under, next to, inside of, or at any other appropriate position relative to a surface to be machined.

Process 500 also calls for positioning and activating a laser tracking system (operation 508). The laser tracking system may be located at any position that is relatively stable relative to the surface to be machined. In implementations in which the surface is annular, for example, the laser tracking system may be located at the center of curvature of the annular surface. The laser tracking system is activated, and initial measurement of the surface measurement system's position may be made, to ensure that the system is functioning properly.

Process 500 calls for the measurement of multiple surface points at the current measurement system location (operation 512). The measurements may, for example, be made with a laser scanning system located on the measurement cart. Additionally, the position (e.g., location and orientation) of the surface measurement system may be measured with the laser tracking system (operation 516). Thus, the locations of the surface points relative to the laser tracking system can be determined.

Process 500 then determines whether more measurements of the surface to be machined should be made (operation 520). In certain implementations, measurements are made until the measurement cart has moved over the entire surface. If more measurements of the surface are to be made, the location of the measurement system is adjusted (operation 524), and the surface measurement system measures multiple surface points at its new location (operation 512).

Once all of the surface measurements have been made, process 500 calls for determining an estimated shape for the surface to be machined (operation 528). The estimated shape is based on the surface measurements. The estimated shape may, for example, be determined using a least squares analysis on the surface measurements. The estimated shape and the measurements may then be stored (operation 532). The storage of this data may, for example, be in a non-volatile memory (e.g., a hard drive or compact-disk) so that it can be retrieved and used during a later operational phases.

Although FIG. 5 illustrates a process for measuring a surface to be machined, other process for measuring a surface to be machined may include less, more, and/or a different arrangement of operations. For example, the measurements of the surface points and the measurement system may occur in any order. As another example, the measurements may be stored as they are made. As an additional example, a process may not call for adjusting the cart location. For instance, the measurement cart may move under its own power and control over the surface to be machined, and the measurements may be made as the cart moves. Moreover, some implementations may use an operator to move the measurement system over the surface. As //ar other example, the measurements of the surface and of the measurement system may need to be collated before determining the estimated shape. Additionally, a number of the operations may be performed in a contemporaneous and/or simultaneous manner. For example, measuring the surface points and location of the measurement system may be performed while the cart moves over the surface. As another example, the measurements may be stored as they are made.

In implementations in which the surface to be machined is not planar (e.g., the outside or inside of a cylinder), the estimated shape and/or machining shape are generally not flat. For example, they may generally conform to the shape of the surface being measured.

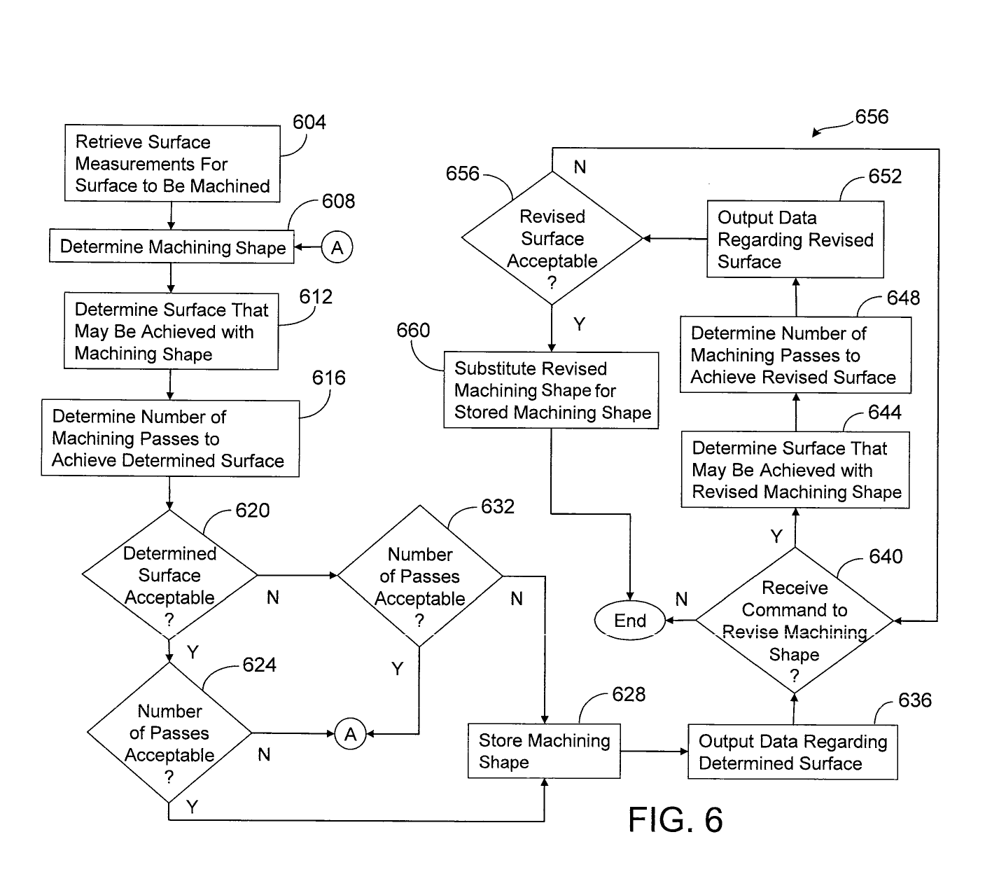

FIG. 6 illustrates an example process 600 for selecting a surface to be achieved by machining. The operations of process 600 may, for example, be implemented by a computer system such as computer system 400.

Process 600 calls for retrieving surface measurements for a surface to be machined (operation 604). These measurements may have been performed by any appropriate system, such as system 100, or process, such as process 500. The measurements may be located in local or remote storage and retrieved therefrom by the use of one or more networks and/or busses.

Process 600 uses the surface measurements to determine a machining shape for the surface to be machined (operation 608). The determined machining shape may be based on reducing the amount and/or severity of imperfections in the surface. For example, after repeated uses, surfaces may be come warped, cracked, dented, and/or pitted. But by removing a layer of surface material in accordance with the machining shape, these imperfections may be reduced, eliminated, and/or improved. The machining shape may be planar (e.g., if the surface to be machined is supposed to be flat), cylindrical, spherical, parabolic, or any other appropriate shape. In general, the machining shape may be any appropriate two or three dimensional configuration.

Removing a large layer of surface material (e.g., a few inches), however, is typically quite expensive and time consuming, because a large number of passes have to be made with a machining system. Thus, determining the machining shape may take into account the imperfections in the surface and the amount of material to be removed. For instance some imperfections (e.g., cracks) may need to be completely eliminated, especially if they are wide or long, and some imperfections (e.g., pits) may only need to be addressed if they are too wide. Addressing the less-serious imperfections in the surface may for example, be balanced with the removal of material.

Process 600 also calls for determining the surface that may be achieved with the machining shape (operation 612). For example, the imperfections expected to remain in the surface after machining based on the machining shape may be determined. Process 600 additionally calls for determining the number of machining passes to obtain the determined surface (operations 616). The number of passes may be determined by, for example, estimating how much material an end effector can remove during a pass and/or how much material an end effector can remove before having to be replaced. Various factors, such as the material hardness of the surface and the area of the surface, may have to be taken into account in such determinations. Additionally, the amount of material that may be removed during a pass may be dependent on the imperfections in the surface and the topography of surrounding surface areas.

Process 600 then analyzes the determined surface to determine whether it is acceptable (operation 620). Determining whether the determined surface is acceptable may, for example, take into account the use of the surface. For instance, if the surface is used as a bearing race, the bearings may be taken into account in determining whether imperfections will materially affect the operation of the bearings.

If the determined surface is acceptable, process 600 calls for determining whether the number of machining passes is acceptable (operation 624). For example, having to execute a few machining passes (e.g., 2-3) is typically acceptable, and sometimes several machining passes (e.g., 5-6) are required. However, large number of machining passes (e.g., greater than ten) are typically only performed in extreme cases.

If the number of machining passes is acceptable, the determined machining shape is stored (operation 628). This machining shape may be the one actually used in machining the surface. If, however, the number of machining passes is not acceptable, process 600 calls for determining a new machining shape (operation 608). This new determination may take into account that the number of passes for the prior machining shape was found to be unacceptable.

If the determined surface is not found to be acceptable in operation 620, process 600 calls for determining whether the number of machining passes to achieve the determined surface is acceptable (operation 632). If the number of machining passes is acceptable, which indicates that further machining may be available, process 600 calls for determining a new machining shape (operation 608). If, however, the number of passes is not acceptable, process 600 calls for storing the machining shape (operation 628). This machining shape may have to be inspected and/or adjusted by an operator to determine whether and/or how to improve the machining shape.

As illustrated, process 600 can determine the machining shape a number of times. The determination process ends once process 600 reaches a balance between an acceptable surface and the number of machining passes or cannot find an acceptable surface.

Upon storing a machining shape (operation 628), process 600 calls for outputting data regarding the surface associated with the machining shape (operation 636). This data may be displayed, printed, and/or sent to an operator and include information regarding the position, orientation, smoothness, and defects :.n the determined surface. The data may also include information regarding the amount of effort to be expended to obtain the surface (e.g., number of machining passes, amount of material to be removed, number of end effectors to be used, and amount of time to achieve the determined surface). The data may allow an operator to make a determination regarding whether the machining shape and/or amount of effort is appropriate.

Process 600 continues with determining whether a command to revise the machining shape has been received (operation 640). A command to revise the machining shape may, for example, specify adjusting the location, size, and/or orientation of the machining shape. If a command to revise the machining shape has not been received, process 600 is at an end. If, however, a command to revise the machining shape has been received, process 600 continues with determining a surface that may be achieved with the revised machining shape (operation 644). This determination may be similar to the determination made in operation 612. Additionally, process 600 calls for determining the number of machining passes to achieve the revised surface (operation 648). This determination may be similar to the determination made in operation 616.

Process 600 then outputs data regarding the revised surface (operation 652). The output process and the actual data may be similar to that for operation 636. This data output may allow an operator to make a determination regarding whether the machining shape is appropriate and/or whether the amount of effort is appropriate.

Process 600 then determines whether the revised surface is acceptable (operation 656). This may, for example, be accomplished by waiting to receive an acceptance or rejection command from an operator. If the revised surface is acceptable, process 600 calls for substituting the revised machining shape for the stored machining shape. The revised machining shape may be the one actually used in machining the surface, which will be explained in greater detail below.

If, however, the revised surface is not acceptable, process 600 calls for again waiting to receive a command to revise the machining shape (operation 640). Process 600 can cycle through the operations of receiving a command to revise the machining shape and checking whether the revised machining shape results in an acceptable surface a number or times, but eventually, a finalized machining shape is stored. This machining shape may be used by a machining apparatus to determine the position of an end effector (e.g., a grinder or other machining tool) that generates the final surface.

Process 600 has a variety of features. For example, the process of determining the machining shape is performed by data manipulation techniques. This provides a more accurate determination of an appropriate machining shape, especially as opposed to estimating it by sight. Thus, a machining shape that achieves certain objectives (e.g., reducing certain deformities and eliminating others while only removing a certain amount of material) may be determined. Additionally, the determined machining shape may be adjusted by an operator, and the changes to the machining operations and the resulting machined surface may be provided to the operator. Thus, an operator may investigate adjusting the machining shape while receiving a numerical determination regarding the changes to the machining operations and the resulting machined surface. Moreover, the adjustments may be made by adjusting a few (i.e., 1-10) variables (e.g., location, size, and/or orientation), which provides less chance for operator error. Additionally, the finally determined machining shape may be stored in computer memory for later use.

Although FIG. 6 illustrates a process for selecting a surface to be achieved by machining, other processes for selecting a surface to be achieved by machining may include fewer, additional, and/or a different arrangement of operations. For example, a process may not include an iterative process to try to arrive at the determined machining shape. That is, the determined machining shape may be calculated in one pass. For example, the estimated shape may be the machining shape. The operator may, however, still be allowed to specify revisions to the machining shape, and the process may call for assisting the operator with these revisions. Additionally, the number of machining passes to achieve the determined surface may not be determined. As another example, a process may include additional operations to stop the iterative process. For instance, the process may be stopped after a number of attempts (e.g., ten) and/or after only incremental improvements are being made in the surface. As a further example, determining the surface to be achieved with a machining shape and the number of machining passes to achieve the determined surface may be performed in any order. As an additional example, data regarding all of the determined machining shapes may be stored and output. This may assist an operator in assessing an acceptable machining shape. Moreover, a number of the operations may be performed in a contemporaneous and/or simultaneous manner. For example, outputting data regarding a surface may be performed while another surface is determined.

In certain implementations, other criteria (in addition to or separate from the number of machining passes) may be also be used to determine the machining shape. For example, the machining shape may be determined, at least in part, based on minimizing the amount of material removed. Additionally, the machining shape may be determined, at least in part, based on correcting the orientation of the machining shape (e.g., with respect to horizontal). These criteria may also be used in reporting data about the determined surface.

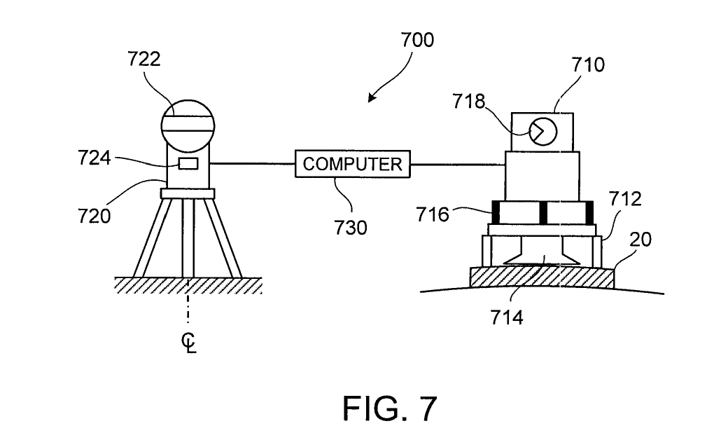

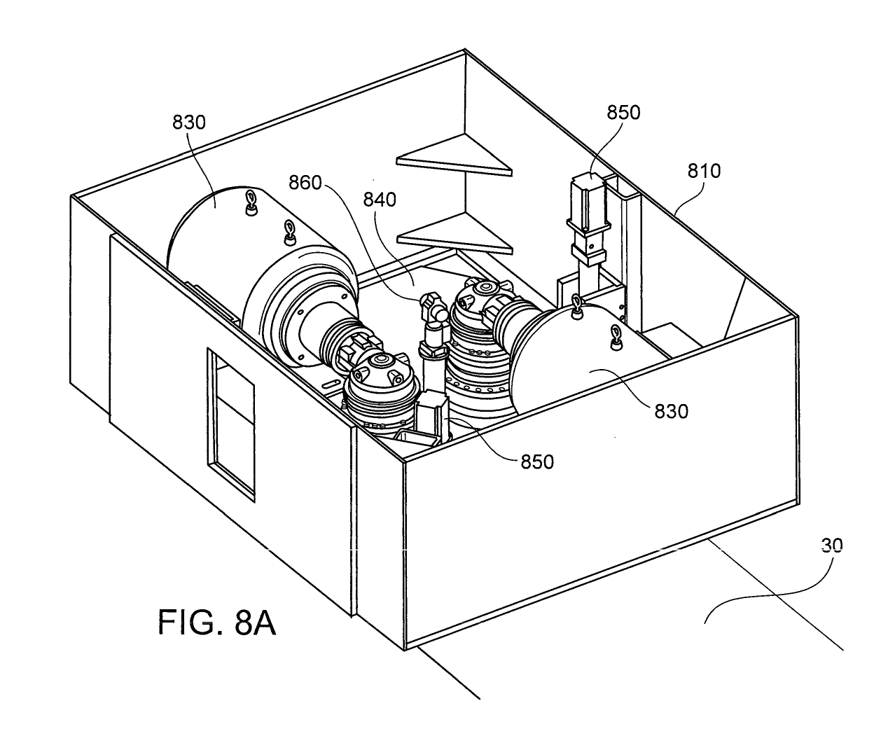

FIG. 7 illustrates an example system 700 for machining a surface 20. Surface 20 may, for example, be the surface of a bearing race. System 700 includes a machining cart 710, a measurement system 720, and a computer system 730.

The machining cart 710 is adapted to travel over and machine the surface 20. The cart 710 includes a travel mechanism 712 (e.g., wheels, tracks, etc.) that allow it to move over the surface 20. The cart 710 may use any coordinate system (e.g., Cartesian or cylindrical) to perform its movements. The cart 710 also includes an end effector 714 (e.g., a machining head) that machines the surface 20. The end effector 714 may, for example, grind, mill, sand, or polish the surface. The end effector 714 may be removable so that different types of end effectors may be used in different passes over the surface. The end effector may be held in contact with the surface during machining due to the weight of the cart.

The machining cart 710 also includes actuators 716 for positioning the end effector 714. In particular implementations, the actuators 716 may be linear actuators. For instance, the actuators 716 may, for example, use ball screws to position the end effector 714. Appropriate ball screws are available from E-Drive of West Hartford, Conn., Nook Industries, Inc. of Cleveland, Ohio and SKF Motion Technologies of Bethlehem, Pa. The actuators may operate in response to commands generated by the computer system 730 to position the end effector 714.

Also coupled to the machining cart 700 is a laser target 718, which facilitates determining the orientation of the end effector 714. In particular implementations, the laser target 718 may be a smart target, which determines the orientation of the end effector. In certain implementations, the laser target 718 may be coupled between the actuators 716 and the end effector 714. Thus, any discrepancy between the orientation of the end effector 714 and the actuators 716 may be reduced.

In particular implementations, a set of passive targets (e.g., targets that cannot detect their orientation) can be used in determining the orientation of the end effector 714. In this case, the information regarding the orientation of the end effector is determined by sensors located with the laser source. The following combinations can be used:

| Number of Laser | Number of |
|---|---|
| Trackers | Passive Targets |
| 1 | 1 |
| 1 | 2 or more |
| 2 | 2 |
| 2 | 3 or more |
| 3 | 3 |
| 4 or more | 1 or more |

When two targets are used, they can be positioned along the normal on the useful plane of the end effector, parallel to the surface to be machined, or at any other angle.

The measurement system 720 is adapted to take measurements that indicate the location of the end effector 714 as the machining cart 710 travels over the surface 20. The measurement system 720 may accomplish this by measuring the location of the laser target 718, from which the location of the end effector 714 may be determined.

In the illustrated implementation, the measurement system 720 includes a centrally located laser source 722. The laser source 722 may illuminate one or more laser targets on the machining cart 710. If the target on the machining cart 710 is passive, the laser source 722 may have one or more co-located sensors. These sensors may produce three-dimensional information regarding the orientation of the end effector 714, which may be sent to the computer system 730. An appropriate laser tracking system is the T3 from API.

The measurement system 720 also includes one or more sensors 724 located with the laser source 722. These sensors may produce three-dimensional information regarding the location of the end effector 714.

The computer system 730 is adapted to receive the information regarding the position (e.g., location and orientation) of the end effector 714. The computer system 730 may, for example, be similar to computer 400. The computer system 730 may analyze the position of the end effector 714 and compare it to the machining shape and/or the actual surface to be achieved to correct the position of the end effector for accurate positioning during machining.

In certain implementations, the computer system 730 may also use the position of the end effector to determine whether to continue machining the surface. The machining shape and the actual surface to be achieved at the location may, for example, be stored in memory of the computer system 730. If further machining is to occur, the computer system 730 may allow the machining cart 710 to continue machining and/or generate a command for the actuators 716 to adjust the orientation of the end effector 714, during or after which machining may continue. When the computer system 730 determines that sufficient machining has occurred at the cart location, it may instruct the machining cart 710 to move to a new location.

The computer system may, for example, determine that sufficient machining has occurred at a location if sufficient material has been removed or the machining shape has been achieved. Sufficient material may have been removed at a location, for instance, if continuing on with the current end effector is not effective (i.e., a different type of end effector is needed for further operations) or further machining would result in defects or difficulties with the neighboring portions of the surface 20.

In particular implementations, the computer system 730 may include a number of computers. For example, a system may have one computer far controlling the laser tracking system and another computer for controlling the machining in a system like system 700. For instance, the computer for controlling the laser tracking system may be a laptop computer, and the computer for controlling the machining may be a programmable logic controller.

System 700 has a variety of features. For example, the process of communicating the machining shape to the computer that controls the machining cart is done by computer. Thus, the vast majority of the data is stored in the computer, and the human errors related to handling that information and trying to adjust components (e.g., a laser source to generate the machining shape) are avoided. Additionally, the position of the end effector can be determined with sensors located near the end effector. Thus, deflection of machining cart components (e.g., actuating arms) by the machining process may be reduced. These reductions in error sources can provide tight tolerances for machining even large surfaces (e.g., thousandths of an inch at 150 foot diameters). Additionally, the system can be set up to machine flat surfaces, circular or non-circular surfaces, as well as surfaces at any angle from the horizontal. The system can machine cylindrical surfaces or any other surface physically feasible. Moreover, the end effector 714 can run on the surface to be machined or can run on other surfaces as needed.

Although FIG. 7 illustrates an example implementation of a surface machining measurement system, other implementations of a surface machining system may include fewer, additional, and/or a different arrangement of components. For example, a surface machining system may include a guide system for guiding the machining cart over the surface. Additionally, a machining cart may be maneuvered by an operator (e.g., by hand) over the surface to be machined. As another example, a machining cart (except for certain end effectors during machining) does not have to touch the surface to be machined. The machining cart may, for example, be held proximate the surface to be machined by a boom or an X-Y system, which may also move the machining cart. In general, the machining cart may be positioned at any distance at which the end effector(s) may appropriately affect the surface. Moreover, a machining cart could be positioned above, under, next to, inside of, or at any other appropriate position relative to a surface to be machined and move over the surface at any appropriate relationship (e.g., above, under, next to, or inside of).

As an additional example, the laser source 722 does not have to be located at the exact center of the surface. In certain implementations, for instance, it could be located a few meters off of the center or even outside the surface. Moreover, the laser source does not have to be located horizontal with the target. As a further example, although illustrated as being coupled between the measurement system 720 and the machining cart 710, the computer system 730 could be located at any of a number of positions on the system (e.g., on the laser tracking system 720 or the machining cart 710) or off the system. Moreover, the computer system 730 does not have to be coupled to any other components. As another example, the laser source 722 (and the associated sensors 724) can be installed on the machining cart 710, while the laser target 718 can be installed at another location (e.g., the center of the workpiece).

In particular implementations, a measurement cart, such as the measurement cart 110, may be convertible into a machining cart, such as the machining cart 710. For instance, the surface measurement system 112 of the measurement cart 110 may be deactivated or removed after the measurement operations are complete, and the laser targeting system may be synched with the target associated with the end effector(s). The end effector(s) may be left on the cart during measurement operations or installed on the cart when the measurement operations are complete. Thus, the measurement cart may be convertible into the machining cart with no or minimal structural changes.

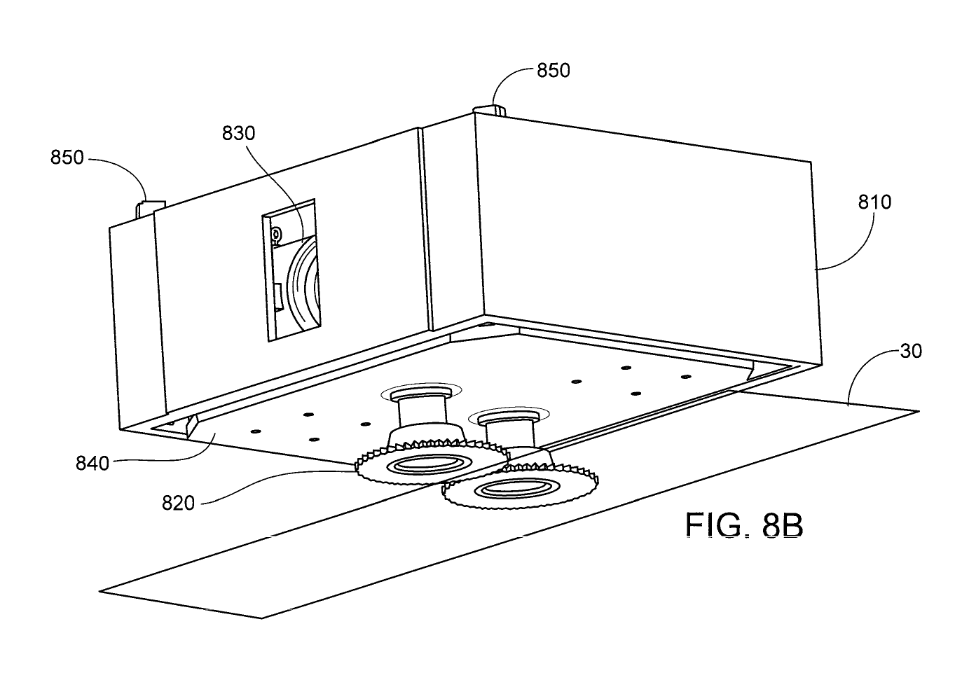

FIGS. 8A-B illustrate an example machining cart 800. Machining cart 800 may be useful in a system similar to system 700. Machining cart 800 includes a body 810, end effectors 820, motors 830, a frame 840, and actuators 850.

The body 810 provides a form to the machining cart 800 and supports its various components. Below the body 810 are end effectors 820, which may machine a surface 30. The end effectors 820 may be removable so that different types of end effectors may be used in different passes over the surface 30. Inside the body are motors 830 for driving the end effectors 820. The motors 830 may, for example, be electrically powered, but could be powered hydraulically or by any other appropriate technique.

The motors 830 and the end effectors 820 are coupled to a frame 840 (e.g., a plate). The frame 840 is at least partially detached from the body 810 to provide for relative motion of the end effectors 820 thereto. The relative motion is provided by the actuators 850, which are coupled to the frame 840 and the body 810. The actuators 850 move the frame 840, and, hence, the end effectors 820, relative to the body 810. Also coupled to the frame 840 is a laser target 860.

In operation, the laser target 860 is illuminated by a laser source that is remote from the machining cart 800 (i.e., at the center of the workpiece). If the laser target 860 is a smart target, it may compute the orientation of the frame 840, which, in turn, translates to the orientation of the end effectors 820. If the laser target is passive, the orientation may be determined by an external sensor. The laser target also reflects the laser beam to one or more external sensors that may determine the three-dimensional location of the target, which may be translated to the position of the end effectors 820, with our without the help of other sensors. Based on the location and orientation of the end effectors, a computer may generate commands for the actuators 850, which may move the frame 840, and, hence, the end effectors 820, relative to the body 810.

The motors 830 may also operate under the control of the computer. For instance, the motors 830 may receive commands regarding when to start operating and when to stop operating. The motors may also receive commands regarding how fast they are moving. Thus, the end effectors 820 may begin operation when they are appropriately positioned and cease operation when they are out of position or when the machining cart 800 needs to be moved to a new location.

Although FIGS. 8A-B illustrates one implementation of a machining cart 800, other implementations may include fewer, additional, and/or a different arrangement of components. For instance, a machining cart may include any number of end effectors 820 and/or actuators 850. As another example, the controlling computer could be located on the machining cart. As an additional example, a machining cart may include the laser tracking system and not include the laser target, which could be located at another location. As a further example, a machining cart may include apparatuses (e.g., rollers) to allow the cart to travel over the surface to be machined. The apparatuses may, for example, be driven by motors on the machining cart. As an additional example, the actuators may adjust the orientation of the entire machining cart to adjust the position (e.g., location and/or orientation) of the end effector(s). For instance, in implementations in which a boom is used, the actuators may adjust the orientation of the cart relative to the boom.

In particular implementations, the end effectors may be used to add material to the surface being machined. For instance, if there are cracks, voids, or valleys in the surface, an end effector may be fitted that deposits material into these areas. The material may be deposited by sputtering, soldering, brazing, or welding techniques. Thus, machining a surface may include removing material from a surface (e.g., grinding, milling, sanding, or polishing), adding material to a surface (e.g., sputtering, soldering, brazing, or welding), or any other technique for modifying the surface.

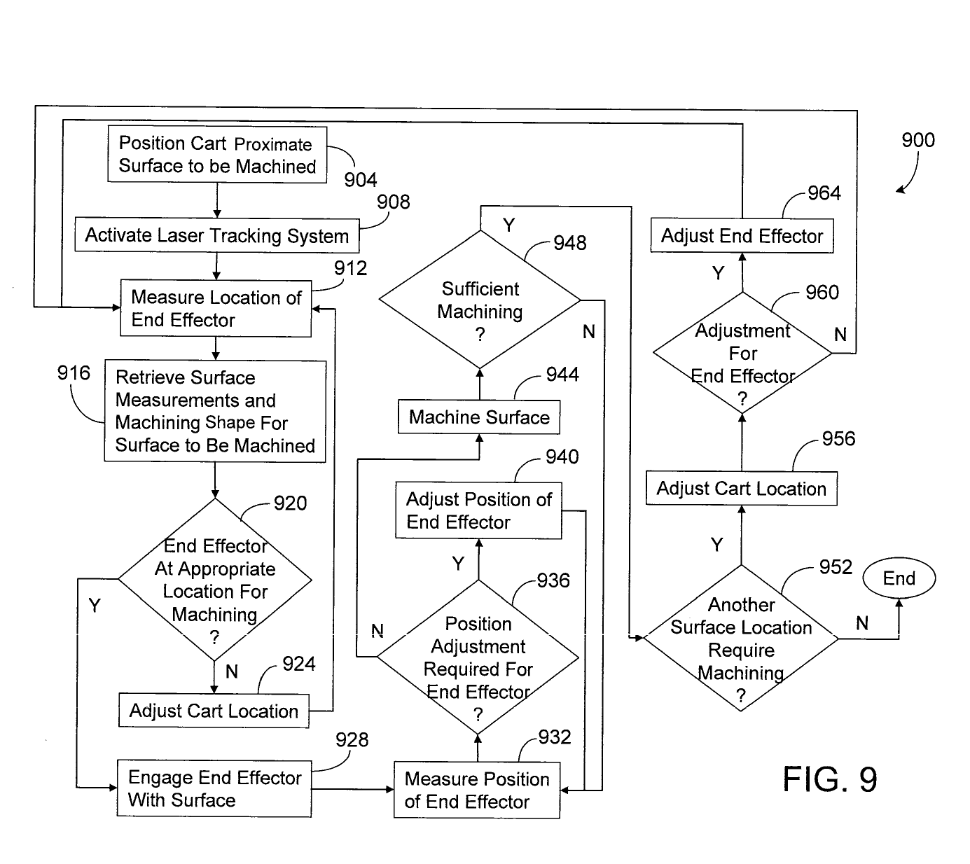

FIG. 9 illustrates an example process 900 for machining a surface. Process 900 may, for example, be implemented by a system similar to system 700.

Process 900 calls for positioning a machining cart proximate the surface to be machined (operation 904). For example, a machining cart such as car: 710 may be placed on the surface to be machined. In other implementations, however, a machining cart (except for particular machining heads during machining) does not have to touch the surface to be machined (e.g., the machining cart could be suspended by a boom). In general, the machining cart may be positioned at any distance at which the machining heads can appropriately make contact with the surface to be machined.:Moreover, a machining cart could be positioned above, under, next to, inside of, or at any other appropriate position relative to a surface to be machined.

Process 900 also calls for activating a laser tracking system (operation 908). The laser tracking system may have been previously located at a position that is relatively stable relative to the surface being measured. In implementations in which the surface is annular, the laser tracking system may be located at the center of curvature of the annular surface. The laser tracking system is activated, and initial measurement of the end effector's location is made (operation 912), to ensure that the system is functioning properly and to determine the end effector's location. Determining the end effector's location may be accomplished by directly measuring the location of the end effector or measuring some other location on the cart, which can be translated to the end effectors location.

Process 900 calls for retrieving surface measurements and a machining shape for the surface to be machined (operation 916). The measurements and the machining shape may, for example, be stored in a local or remote computer memory. The machining shape may be planar (e.g., if the surface to be machined is supposed to be flat), cylindrical, spherical, parabolic, or any other appropriate configuration.

Process 900 also calls for determining whether the end effector is in an appropriate location for machining (operation 920). For instance, the end effector may be located at a position at which no machining needs to occur. As another example, the end effector may not be located at the best position for machining certain defects (e.g., on the edge of a peak).

If the end effector is not located at an appropriate location, the cart's location may be adjusted (operation 924). The adjustment may, for example, take into account the best location to machine a feature. Process 900 then again measures the location of the end effector (operation 912) and determines whether it is at an appropriate location for machining (operation 920).

Once the end effector is at an appropriate location for machining, process 900 calls for engaging the end effector with the surface (operation 928) and measuring the position of the end effector (operation 932). In particular implementations, measuring the end effector's position may be accomplished with the laser tracking system. A laser target may, for example, be located near the end effector (e.g., between an actuator for the end effector and the end effector) to give an accurate measurement of the end effector's orientation (e.g., roll, pitch, and yaw). In certain implementations, the target may be located away from the end effector such that the position of some other point on the cart is measured, and then the position of the end effector is derived.

Process 900 calls for determining whether a position adjustment is required for the end effector (operation 936). A position adjustment may; for example, be required to ensure that the end effector is adequately engaged with the surface. If a position adjustment is required, process 900 calls for adjusting the position of the end effector (operation 940). Adjusting the position of the end effector may, for example, be accomplished by sending a command to one or more actuators for the end effector. Process 900 then calls for again measuring the position of the end effector (operation 932) and determining whether a position adjustment is required (operation 936).

Once the end effector is determined to be in an appropriate position, process 900 calls for machining the surface (operation 944). Machining the surface may, for example, include grinding or milling. Process 900 also calls for determining whether sufficient machining has occurred (operation 948). This determination may, for example, be made based on the time that a machining operation has been occurring or the position of the end effector, which may be based on the machining shape. Sufficient machining may not necessarily result in a finished surface, especially when multiple types of machining operations have to be performed on the surface. Thus, a variety of intermediate machining shapes may be achieved. If sufficient machining has not occurred, process 900 calls for continuing to measure the position of the end effector (operation 932), perform position adjustments if needed (operations 936 and 940), and machining the surface (operation 948).

Once sufficient machining has occurred at the current location, process 900 calls for determining whether another surface location requires machining (operation 952). If another surface location does not require machining (which typically does not happen until the machining cart has made several passes over the surface), the process 900 is at an end. If, however, another surface location requires machining, process 900 calls for adjusting the cart location (operation 956) and determining whether an adjustment for the end effector is required (operation 960). The end effector may, for example, require an adjustment if it has been used to remove a given amount of material (e.g., the end effector is dull or worn out) or if another type of end effector is required for the next surface location (e.g., grinding versus milling)

If no adjustment is required for the end effector, process 900 calls for again preparing the machining cart for machining (e.g., making sure the end effector is in the proper location (operation 920), engaging the end effector with the surface (operation 928), and making sure the end effector is in the proper position (operation 936)). If, however, an adjustment for the end effector is required, the end effector is adjusted (operation 964). The machining cart is then prepared for machining at the new location.

Although FIG. 9 illustrates a process for machining a surface, other processes for machining a surface may include fewer, additional, and/or a different arrangement of operations. For example, a process may include scanning the surface during and/or after machining to determine the current state of the surface. Moreover, a number of the operations may be performed in a contemporaneous and/or simultaneous manner. For example, a process may continually measure the position of the end effector during machining. Additionally, more laser sources may be used with one or more targets, or one laser may be used with one or more targets.

As another example, determining whether sufficient machining has occurred at a location and determining an adjustment for the location of the cart may not occur in all implementations. For instance, the cart may have a motive power that moves it over the surface, and the cart may travel over the surface based on this power. In particular implementations, for example, a constant level may be determined for the end effector (e.g., grinder or cutter), and the cart may be allowed to travel over the surface. The level may, for example, be based on the machining shape and may represent an intermediate machining shape. During this travel, the position (e.g., orientation) of the end effector may be tracked and adjusted to maintain the level. Thus, machining may occur as the cart advances, and the speed with which the cart travels over the surface may be dictated by the amount of material that the end effector is removing at any one location (e.g., the more material being removed, the slower the cart will travel). The machining pass may, for example, end when the machining cart has made one pass over the surface. Other machining passes may then be made (e.g., with different levels or end effectors), if required. The various levels and end effectors may also be based on the machining shape and may represent one or more intermediate machining shapes.

A number of implementations have been described, and several others have been mentioned or suggested. Additionally, those skilled in the art will recognize that a variety of additions, deletions, substitutions, and modifications may be made will still achieving surface measurement, selection, and machining. Thus, the protected subject matter should be judged based on the following claims, which may encompass one or more aspects of one or more implementations.

What is claimed is:

1. A system for determining a representation of a surface to be machined, the system comprising:
a measurement system movable over a surface to be machined, the measurement system adapted to measure a plurality of surface points at each of a plurality of surface measurement locations;
a laser tracking system adapted to measure the position of the measurement system; and
a computer system adapted to receive the surface measurements from the measurement system and the measurement system positions from the laser tracking system, a plurality of the measurement system locations corresponding to the surface measurement positions, to determine an estimated shape for the surface to be machined based on the surface measurements at the surface measurement locations, and to store the surface measurements, the surface measurement locations, and the estimated shape.

2. The system of claim 1, wherein the measurement system [s coupled to a measurement cart that is movable in an automated manner over the surface to be machined.

3. The system of claim 2, wherein the cart comprises a travel mechanism adapted to contact and move over the surface to be machined.

4. The system of claim 3, wherein the travel mechanism comprises rollers and a motor to drive the rollers.

5. The system of claim 2, further comprising a central station and an arm rotatably coupled to the central station and extending to the cart.

6. The system of claim 5, wherein the arm is adapted to cause the cart to move around the central station.

7. The system of claim 1, wherein the measurement system comprises a laser scanner adapted to measure the surface at a number of points.

8. The system of claim 1, wherein the computer system is coupled to the measurement system and the laser tracking system.

9. The system of claim 1, wherein the computer system is adapted to use a least squares analysis to determine the estimated shape.

10. The system of claim 1, wherein the laser tracking system is adapted to measure the location and orientation of the measurement system.

11. The system of claim 1, wherein:
the laser tracking system comprises a laser source located away from the surface to be machined; and
a laser target coupled to the measurement system.

12. The system of claim 11, wherein the laser target is adapted to detect its orientation with respect to a reference system.

13. A computer-implemented method for determining a representation of a surface to be machined, the method comprising:
measuring a plurality of surface points at each of a plurality of surface measurement locations with a measurement system movable over a surface to be machined;
measuring the position of the measurement system;
determining, using one or more processors, an estimated shape for the surface to be machined based on the surface measurements at the surface measurement locations; and
storing the surface measurements, the surface measurement locations, and the estimated shape in computer memory.

14. The method of claim 13, wherein measuring the plurality of surface points comprises measuring the surface points with a measurement cart includes the measurement system and moves in an automated manner over the surface to be machined.

15. The method of claim 13, further comprising:
determining whether additional surface measurements are needed; and
adjusting the position of the measurement system based on the results of the determination.

16. The method of claim 15, wherein adjusting the position of the measurement system comprises generating a movement command for a measurement cart to which the measurement system is coupled.

17. The method of claim 13, wherein measuring the position of the measurement system comprises sending a laser beam from a laser source located away from the surface to be machined to a laser target coupled to the measurement system.

18. The system of claim 17, wherein measuring the position of the measurement system comprises determining the orientation of the measurement system with the laser target.

19. A system for determining a representation of a surface to be machined, the system comprising;
means for measuring a plurality of surface points at each of a plurality of surface measurement locations, the measuring means movable over a surface to be machined;
means for measuring the position of the measuring means;
means for determining an estimated shape for the surface to be machined based on the surface measurements at the surface measurement locations; and
means for storing the surface measurements, the surface measurement locations, and the estimated shape.

20. The system of claim 19, wherein the means for determining the estimated shape is further operable to:
determine whether additional surface measurements are needed; and
adjust the position of the measuring means based on the results of the determination.

21. The system of claim 20, wherein adjusting the position of the measuring means comprises generating a movement command for a measurement cart to which the measuring means is coupled.

22. The system of claim 19, wherein the means for measuring the position of the surface measuring means comprises a laser source means located away from the surface to be machined and a laser target means coupled to the surface measuring means.

23. A system for determining a representation of a surface to be machined, the system comprising:
a measurement cart movable in an automated manner over a surface to be machined, the measurement cart comprising:
rollers adapted to contact and move over the surface to be machined,
a motor to drive the rollers, and
a laser scanner adapted to measure a plurality of surface points at each of a plurality of surface measurement locations;
a central station and an arm rotatably coupled to the central station and extending to the cart, the arm adapted to cause the cart to move around the central station;
a laser tracking system located near the central station and adapted to measure the location and orientation of the laser scanner, the laser tracking system comprising:
a laser source located away from the surface to be machined,
a sensor co-located with the laser source, the sensor adapted to measure the location of the laser scanner, and
a laser target coupled to the laser scanner, the laser target adapted to measure the orientation of the laser scanner; and
a computer system coupled to the cart and the laser tracking system and adapted to receive the surface measurements from the laser scanner and the laser scanner orientations and the laser scanner locations from the laser tracking system, a plurality of the laser scanner locations corresponding to the surface measurement locations, to determine an estimated shape for the surface to be machined based on the surface measurements at the surface measurement locations, and to store the surface measurements, the surface measurement locations, and the estimated shape.
